(19) United States
(12) Patent Application Publication
(10) Pub. No.: US 2026/0244896 A1
(43) Pub. Date: Aug. 20, 2026

(54) CODE GENERATION MODEL TRAINING DATA DECONTAMINATION

(71) Applicant: International Business Machines Corporation, Armonk, NY (US)

(72) Inventors: HIROSHI KANAYAMA, Yokohama-shi (JP); Takuya Ohko, TOKYO (JP); Masayasu Muraoka, Kashiwa (JP); Issei Yoshida, Setagaya-ku (JP)

(21) Appl. No.: 19/055,026

(22) Filed: Feb. 17, 2025

(51) Int. Cl. G06N 3/042; G06F 8/35; G06N 3/0475

(52) U.S. Cl. CPC G06N 3/042; G06N 3/0475; G06F 8/35

(57) ABSTRACT

Mechanisms are provided for decontaminating training data for training a code generation large language model (LLM). The mechanisms perform content matching between benchmark data and training data to identify content-sharing data comprising strings that are common between the two. The mechanisms identify one or more repositories that contain instances of the content-sharing data, and generate one or more contamination metrics for each repository based on a frequency of the instances of the content-sharing data in the one or more repositories. The mechanisms identify one or more contaminated repositories in the one or more repositories based on the one or more contamination metrics for each repository. The mechanisms decontaminate the training data based on the identification of the one or more contaminated repositories and metadata of training data samples in the training data. The mechanisms train a machine learning computer model based on the decontaminated training data.

### BACKGROUND

The present application relates generally to a data processing apparatus and method and more specifically to a computing tool and computing tool operations/functionality for performing decontamination of training data for training code generation models.

Large Language Models (LLMs), such as ChatGPT, are advanced machine learning computer models designed to understand and generate human language. LLMs are trained on large amounts of text data, e.g., documents available via the Internet, various curated document repositories, and the like. This enables the LLMs to perform a wide range of natural language processing (NLP) tasks, such as text generation, translation, summarization, and question answering.

Recently, some LLMs have been trained to perform computer code generation tasks. That is, the code generation LLMs receive a prompt or instruction to generate a portion of code to perform a specified operation, and the LLM returns a portion of code that performs that operation. Such code generation LLMs assist developers in writing computer code, finding errors, and translating between programming languages.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises performing content matching between benchmark data and training data to thereby identify content-sharing data, where the content-sharing data comprises strings that are common between the benchmark data and the training data. The method further comprises identifying one or more repositories that contain instances of the content-sharing data, and generating one or more contamination metrics for each repository in the one or more repositories, based on a frequency of the instances of the content-sharing data in the one or more repositories. The method also comprises identifying one or more contaminated repositories in the one or more repositories based on the one or more contamination metrics for each repository. In addition, the method comprises decontaminating the training data based on the identification of the one or more contaminated repositories and metadata of training data samples in the training data. Furthermore, the method comprises training a machine learning computer model based on the decontaminated training data.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a code generation LLM training dataset decontamination system in accordance with one illustrative embodiment;

FIG. 3A is an example diagram of examples of benchmark data samples in accordance with one illustrative embodiment;

FIG. 3B is an example diagram of a record of a repository with corresponding metadata in accordance with one illustrative embodiment; and

FIG. 4 is a flowchart outlining an example operation of a decontamination system in accordance with one illustrative embodiment.

### DETAILED DESCRIPTION

The illustrative embodiments provide a computing tool and computing tool operations/functionality for performing decontamination of training data for training code generation models, such as code generation Large Language Models (LLMs). The illustrative embodiments provide a computing tool that identifies repositories for training data that may be contaminated with benchmark data and uses the metadata of the training data to determine which portions of the training data may originate from such repositories. The illustrative embodiments then remove the potentially contaminated training data to thereby remove benchmark data and decontaminate the training data. The decontaminated training data may then be used as a basis for training the code generation LLM.

In particular, a problem in training code generation LLMs that the present invention is specifically directed to solving is the inclusion of benchmark data in the training datasets used to train the code generation LLM. Benchmark data is used to evaluate the code generation LLM to ensure that it is performing satisfactorily with regard to the generation of code given a prompt or instruction. With regard to code generation LLMs, the benchmark data may comprise samples or instances of an instruction or prompt to write computer code to perform a specified operation or function, along with a corresponding portion of computer code (or simply “code” herein) that the LLM should generated to perform that function or operation, i.e., the canonical solution. In some cases, the benchmark may comprise a portion of source code as the prompt and the solution being the next line of code, or a code snippet. Benchmark data may be manually created, or may come from code repositories, such as Git repositories, for example. Such benchmark data samples may be used to test a trained code generation LLM to determine how closely the trained code generation LLM's output, given the benchmark instruction/prompt, is to the benchmark code.

Various benchmark datasets exist for evaluating such code generation LLMs, examples of which include MBPP, CanltE-dit, DS1000, HumanEval, CodeNet, CrossCodeEval, and the like. However, if the benchmark data is present in the training data, then the code generation LLM will be trained on the benchmark data as well as the other training data, which may cause the code generation LLM to be trained specifically for the benchmark cases and skew the evaluation of the resulting code generation LLM to have higher performance than it otherwise would. As a result, the code generation LLM may not operate properly in previously unseen code generation scenarios, yet may be inaccurately evaluated as having a better performance during evaluation based on the benchmark data.

Hence, it is important to decontaminate the training data used to train code generation LLMs before training them, such as by removing instances of benchmark data from the training data. In natural language versions of LLMs, decontamination of training datasets can be performed by performing semantic similarity evaluations. However, such mechanisms do not work when it comes to code generation LLMs due to the significant differences in benchmark datasets and code generation tasks. That is, for code generation LLMs, benchmark datasets are diverse and may include code generation benchmark data, code translation benchmark data, mathematical problems, code explanations, and the like. In code generation tasks, strict syntax is important, unlike question-answer pairs in language model benchmarking, semantic similarity is not a good measurement to detect potential contamination in code generation LLMs. This is especially true since code generation benchmark datasets often include short code snippets, e.g., “return x+y”, which may cause many false positives if semantic similarity is used to decontaminate training data which may have similar, but different, portions of code. The decontamination operation itself may potentially degrade the code generation LLM, e.g., when a benchmark asks “write a code of Fibonacci sequence”, should all documents that contain the term “Fibonacci” be removed from the training data?

Thus, the problems in decontamination of training datasets with benchmark data include false negatives, where problematic data is not detected and remains in the training dataset, even if there are overlaps between the benchmark and training sets and these overlaps may help the LLM to solve the test cases. The failure of detection may be caused by a difference in formats and expressions between the benchmark data and the training dataset. Moreover problems include false positives where harmless codes are wrongfully regarded as contamination due to short and general code snippets being used in the benchmark and training datasets. Over-detection of contamination may shrink or bias the training data and may degrade the quality of the trained code generation LLM. In addition, problems in decontamination of training datasets include the computational costs of the decontamination, e.g., since the training data is large, the cost to match all pairs of benchmark and training sets is not ignorable.

The illustrative embodiments provide a computing tool and computing tool operations/functionality specifically directed to decontamination of training data for training code generation LLMs. It should be appreciated that while the primary illustrative embodiments will be described in the context of training a code generation LLM, the mechanisms of the illustrative embodiments may be implemented with regard to training datasets for other types of machine learning computer models where benchmark data being present in training datasets may cause issues with the training of the machine learning computer models. Thus, the illustrative embodiments may be implemented to improve the training of such other types of machine learning computer models as well and is not limited to code generation LLMs. The code generation LLM embodiments are provided herein as an example and those of ordinary skill in the art will readily identify other applications of the illustrative embodiments to other types of machine learning computer models in view of the present description.

The illustrative embodiments perform a content matching between benchmark data and training data to identify instances of the benchmark data in the training data. That is, a string matching is performed between the training dataset and the benchmark dataset. If strings in the benchmark dataset are present in the training dataset, these common strings, referred to herein as content-sharing data, are regarded as potential contamination and the corresponding benchmark dataset ID is attached to the training data as an annotation so that it can be removed from the training dataset. Before the string matching, normalization is applied, such as white space removal, special characters (e.g., newline characters) removal, conversion of upper case to lower case, and the like. In addition, other techniques may be used to enhance the string matching including exclusion of short strings having a length below a given threshold, so as to eliminate frequently used code snippets that may lead to false positives. Comment removal may be used to remove comment lines in code before performing string matching.

To reduce computational costs of the string matching, metadata of the training data can be used to determine when string matching can be skipped, e.g., when the programming language of the benchmark data and the training data are different. In addition, the training data may be cleansed by performing deduplication of the training data samples. Moreover, deduplication of strings may be performed such that when there are overlaps of strings in a same benchmark dataset, they are merged into one string for purposes of string matching with the training dataset.

The content-sharing data is used to search repositories for instances of the content-sharing data to determine which repositories are potentially contaminated with benchmark data. The repositories store documents used by code generation LLMs to perform code generation operations. The documents may have various types of content including actual computer code in various programming languages, natural language text code explanations, computer code issues and commits, and the like. One example of a code repository is starcoderdata which is a repository of training data used to train the StarCoder language model for code generation.

The repositories may be scored and ranked based on a frequency of occurrence of content-sharing data. For example, the scoring may be a function of an evaluation of the number of occurrences of content-sharing data in the repository, the number unique instances of content-sharing data, a percentage of the repository that contains content-sharing data relative to the total size of the repository, or the like. Based on the scoring and/or ranking of the frequency of occurrence of the content-sharing data, a listing of repositories and the scores/ranks may be generated that indicate which repositories are more/less contaminated with benchmark data. Thresholds may be established for determining when the degree of potential contamination is such that the repository should be considered contaminated for purposes of decontamination of training datasets, as discussed hereafter.

In some illustrative embodiments, it is a possible (and simplest) to determine that a repository is contaminated if it contains at least one instance (document) of the content-sharing data, however more complex and varied embodiments may also be implemented. For example, assume that there are two repositories A and B. Repository A contains 100 documents and repository B contains 10,000 documents, and both repositories A and B contain 5 instances of the content-sharing data. Then, for a repository X, one can define r(X), the degree of contamination of X, as the ratio of the number of the documents of the content-sharing data in X over the number of all the documents of X. In this case, r(A)=0.05 and r(B)=0.0005, which indicates that repository A is more likely to be contaminated than repository B. If a threshold t is set for r, to be 0.001, for example, then r(A)>0.001 holds while r(B)>0.001 does not. The illustrative embodiments can use this inequality to determine if a document in X should be removed from the training data to see if r(X) >t holds. The desirable property of the function r is that the value of r is between 0 and 1, and a larger value of r(X) indicates that X is more likely to be contaminated. Any function r that satisfies this property is available for scoring.

In some illustrative embodiments, after setting the score for the repository-based matching as discussed above, the repository score is combined with the content-based matching score, which may be a similarity score. For example, this similarity score may be based on syntax and semantic similarity, 0≤sim≤100, which can be normalized as 0≤c≤1). Both the content score and repository score may be used in the decontamination decision (whether to exclude the document from the training data), such that a total score s may be defined as s=(1−α)c+αr, where c is a score of content matching, r is the degree of contamination for the source repository, α is an empirically set value, and the threshold θ is also determined empirically to decontaminate the data when s>θ. For example, by empirically setting α=0.9 and θ=0.1, a document in the training dataset that has a similarity score c=0.8 with a specific benchmark instance, and r=0.1 (e.g., 10 out of 100 data from the repository are content-sharing data), s=0.1*0.8+0.9*0.1=0.17, which exceeds the threshold θ and thus, the document in question is removed from the training dataset.

The simple case of a repository having any content-sharing data, mentioned previously, can also be formalized as follows: c=1 if the string of the test data is a substring of the training data, 0 otherwise, r=1 if the repository has 50 or more content-sharing data, 0 otherwise, α=0.5, and θ=0.1. Then the potential contamination can be found as either of a string match or any datasets from the contaminated repositories. These are only examples of some illustrative embodiments for scoring the matching and with benchmarks and the scoring of repositories, but are not intended to be limiting on the possible embodiments. Any other suitable scoring may be utilized without departing from the spirit and scope of the present invention, as long as it achieves the purposes of identifying repositories that may be potentially contaminated.

The listing of repositories that are potentially contaminated, i.e., contain content-sharing data to a sufficient degree that they are considered contaminated for purposes of decontaminating training datasets, may be used to identify which portions of the training data are actual contamination of the training data by benchmark data, and which may be false positives. That is, many benchmark datasets are generated from such repositories and thus, the repositories may contain benchmark data. Thus, the illustrative embodiments identify which repositories have instances of content-sharing data, i.e., data having common strings between benchmark data and training data, and then determines which portions of the content-sharing data in the training data originate from a repository that has been determined to be contaminated. These represent the true positives of potential contamination, whereas other instances that may not originate from a contaminated repository may be considered false positives.

Moreover, in some illustrative embodiments, the illustrative embodiments may be used to reduce instances of false negatives in the content matching by assuming that all training data originating from a contaminated repository are in fact contamination in the training dataset. This may be the case even for forked repositories that originate from a contaminated repository, as the forked repository may be assumed to be also contaminated. In such embodiments, the training datasets may be decontaminated by not only removing instances of content-sharing data detected based on string matching between the benchmark data and the training data, but also based on metadata specifying the repository source of training data. That is, for training data samples that originate from a contaminated repository, those training data samples may be removed from the training dataset without having to perform string matching between the benchmark data and the training dataset. The remaining training dataset samples may then be subjected to string matching between the benchmark dataset and the training dataset to identify instances of content-sharing data which may then be removed from the training dataset.

Thus, the illustrative embodiments provide computer tools and computer operations/functionality to decontaminate a training dataset with regard to benchmark data. This may be done using a combination of metadata based identification of training data samples that originate from identified contaminated repositories, as well as string matching. In some illustrative embodiments, false positives and true positives may be distinguished based on such metadata and the identification of contaminated repositories. The resulting decontaminated training dataset may then be provided to training logic for training a code generation LLM. As a result, the trained code generation LLM will not be trained on benchmark data and hence, the benchmark datasets may be accurately used to evaluate the performance of the trained code generation LLM.

The following description provides examples of embodiments of the present disclosure, and variations and substitutions may be made in other embodiments. Several examples will now be provided to further clarify various aspects of the present disclosure.

Example 1: A method comprising performing content matching between benchmark data and training data to thereby identify content-sharing data, where the content-sharing data comprises strings that are common between the benchmark data and the training data. The method further comprises identifying one or more repositories that contain instances of the content-sharing data, and generating one or more contamination metrics for each repository in the one or more repositories, based on a frequency of the instances of the content-sharing data in the one or more repositories. The method also comprises identifying one or more contaminated repositories in the one or more repositories based on the one or more contamination metrics for each repository. In addition, the method comprises decontaminating the training data based on the identification of the one or more contaminated repositories and metadata of training data samples in the training data. Moreover, the method comprises training a machine learning computer model based on the decontaminated training data. The above limitations advantageously enable improved training of machine learning computer models by removing benchmark data from training data in an efficient manner based on the identification of contaminated repositories from which training data may be obtained.

Example 2: The limitations of any of Examples 1 and 3-10, where decontaminating the training data comprises, for each training data sample in the training data, comparing one or more first attributes of the training data sample in the metadata of the training data sample, to one or more second attributes of the one or more contaminated repositories, and in response to identifying a match of at least one first attribute of the training data sample with an at least one second attribute of a contaminated repository of the one or more contaminated repositories, removing the training data sample from the training data. The above limitations advantageously enable the removal of training data samples having an attribute that matches an attribute of a contaminated repository so as to ensure that the training data samples of the training data do not have potential contamination by benchmark data.

Example 3: The limitations of any of Examples 1-2 and 4-10, where the one or more first attributes comprises an identifier of a source repository from which a corresponding training data sample was obtained, and wherein the one or more second attributes comprises a repository identifier of a corresponding contaminated repository. The above limitations advantageously enable the removal of training data samples that originate from contaminated repositories so as to ensure that the training data does not have contamination from these contaminated repositories.

Example 4: The limitations of any of Examples 1-3 and 5-10, where decontaminating the training data comprises performing a preprocessing of the training data to identify portions of the training data which are not to be a target for decontamination, and where the preprocessing comprises identifying portions of the training data that are in a different computer programming language from a programming language of the benchmark data. The above limitations advantageously enable more efficient evaluation of content-sharing data between benchmark data and training data by skipping portions that are in a different programming language and thus, are not likely to have benchmark data from a benchmark dataset that is in a different programming language.

Example 5: The limitations of any of Examples 1-4 and 6-10, where the one or more contamination metrics comprises at least one of a number of instances of content-sharing data in the one or more repositories or a number of unique instances of content-sharing data in the one or more repositories. The above limitations advantageously enable the differentiation of repositories that are contaminated and repositories that are not contaminated based on an evaluation of a frequency of occurrence of content-sharing data in the repositories.

Example 6: The limitations of any of Examples 1-5 and 7-10, where the one or more contamination metrics comprises a degree of contamination of a corresponding repository, and where the degree of contamination is a function of a ratio of a number of documents in the corresponding repository having instances of the content-sharing data to a total number of documents of the corresponding repository. The above limitations advantageously enable the differentiation of repositories that are contaminated and repositories that are not contaminated based on an evaluation of a degree of contamination of the repositories.

Example 7: The limitations of any of Examples 1-6 and 8-10, where performing content matching between benchmark data and training data to thereby identify the content-sharing data further comprises annotating training data samples in the training data that have content-sharing data with a benchmark annotation specifying an identifier of the benchmark data, and where training data samples annotated with a benchmark annotation are candidates for removal from the training data. The above limitations advantageously enable marking training data samples that are candidates for removal from the training data so that these marked training data samples may be further evaluated for determining whether they should be removed from the training data.

Example 8: The limitations of any of Examples 1-7 and 9-10, where the one or more contamination metrics comprise a function of a length of content-sharing data string instances present in a corresponding repository. The above limitations advantageously enable the identification of contaminated repositories based on lengths of content-sharing data string instances in the repository, recognizing that shorter lengths have a higher likelihood of not being representative of contamination, and longer lengths have a higher likelihood of being representative of contamination.

Example 9: The limitations of any of Examples 1-8 and 10, where the machine learning computer model is a code generation large language model (LLM). The above limitations advantageously enable improved training a code generation LLMs by minimizing or eliminating benchmark data in the training data, such that the benchmark data may be accurately used to evaluate the performance of the trained code generation LLM.

Example 10: The limitations of any of Examples 1-9, where the one or more repositories are code generation repositories comprising documents used by the code generation LLM to generate computer code to perform a function specified in a prompt input to the code generation LLM. The above limitations advantageously enable identification of code generation repositories that may be corrupted by the inclusion of benchmark data which may cause the trained code generation LLM to not be able to be properly evaluated using the benchmark data.

Example 11: A system comprising one or more processors and one or more computer-readable storage media collectively storing program instructions which, when executed by the one or more processors, are configured to cause the one or more processors to perform a method according to any one of Examples 1-10. The above limitations advantageously enable a system comprising one or more processors to perform and realize the advantages described with respect to Examples 1-10.

Example 12: A computer program product comprising one or more computer readable storage media, and program instructions collectively stored on the one or more computer readable storage media, the program instructions comprising instructions configured to cause one or more processors to perform a method according to any one of Examples 1-10. The above limitations advantageously enable a computer program product having program instructions configured to cause one or more processors to perform and realize the advantages described with respect to Examples 1-10.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides training dataset decontamination based on metadata specifying sources of training data and string matching. The improved computing tool implements mechanism and functionality, such as the code generation LLM training data decontamination system, which cannot be practically performed by human beings either outside of, or with the assistance of, a technical environment, such as a mental process or the like. The improved computing tool provides a practical application of the methodology at least in that the improved computing tool is able to improve training of code generation LLMs by decontaminating training datasets to remove benchmark data which permits benchmark datasets to be used to evaluate performance of the trained code generation LLMs.

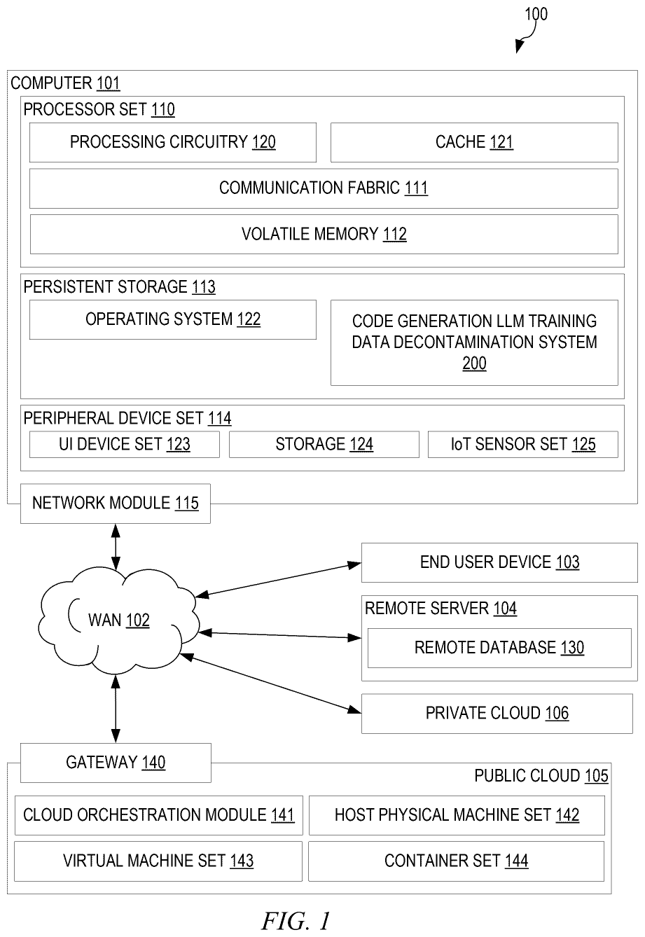

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as code generation LLM training data decontamination system 200, referred to herein simply as the decontamination system 200. In addition to decontamination system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and decontamination system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in decontamination system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in decontamination system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a decontamination system 200 that operates to decontaminate training datasets with regard to benchmark data. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates improved training of code generation LLMs by decontaminating training datasets from having benchmark data. By removing the benchmark data from the training datasets, the trained code generation LLMs may be evaluated against benchmark data to obtain accurate representations of the performance of the code generation LLMs.

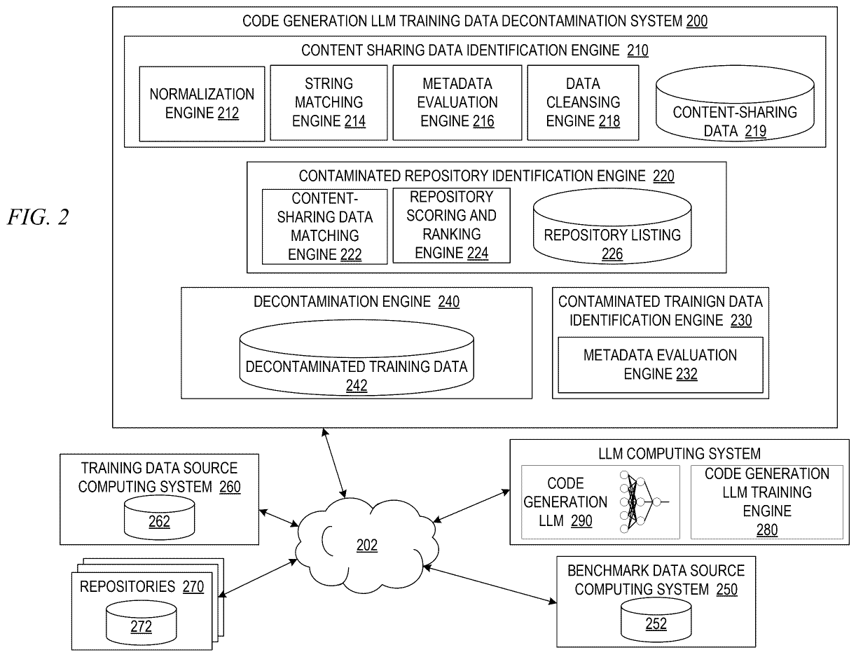

FIG. 2 is an example block diagram illustrating the primary operational components of a code generation LLM training dataset decontamination system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that code generation LLMs are trained, and providing a specific solution that implements content-sharing data identification between benchmark datasets and training datasets, identification of repositories that are potentially contaminated with benchmark data, and decontamination mechanisms to remove benchmark data from training datasets based on the identification of content-sharing data and the metadata specifying repository sources of the training data, which cannot be practically performed by human beings as a mental process and is not directed to organizing any human activity.

As shown in FIG. 2, the code generation LLM training dataset decontamination system, also referred to simply as a decontamination system 200, comprises a content-sharing data identification engine 210, a contamination repository identification engine 220, a contaminated training data identification engine 230, and a decontamination engine 240. The decontamination system 200 communicates with a benchmark data source computing system 250, training data source computing system 260, and code repositories (or simply repositories) 270 via one or more data networks 202. Moreover, the resulting decontaminated training datasets may be provided to code generation LLM training engine 280 for training a code generation LLM 290, also via the one or more data networks 202.

In accordance with one or more illustrative embodiments, the decontamination system 200 operates to decontaminate training datasets, e.g., training dataset 262, with regard to having training data samples with benchmark data present, such as benchmark data samples from benchmark data 252. The decontamination system identifies repositories 270 that comprise repository data matching content shared between the benchmark data 252 and the training data 262, and determines these repositories to be contaminated repositories. Thereafter, metadata of the training data samples in the training data 262 may be evaluated against attributes of the contaminated repositories and the benchmark dataset to determining which training data samples to eliminate from the training dataset, e.g., training data samples originating from the contaminated repository, skipping string matching when programming language differences exist between the benchmark data and the training data sample, and the like. String matching may also be performed to identify the content-sharing data to remove from the training dataset. In some illustrative embodiments, the metadata and string matching may be used to differentiate between true positive and false positive content-sharing data instances and identify which to perform decontamination on. The result is that the mechanisms of the illustrative embodiments are able to minimize or eliminate false negative and false positive identification of contamination in training datasets, as well as reduce computational costs for decontamination of training datasets.

With the mechanisms of the illustrative embodiments of FIG. 2, the decontamination system 200 may be invoked to perform a decontamination of a given training dataset 262 from a training data source computing system 260. For example, prior to the code generation LLM training engine 280 training the code generation LLM 290 using the training dataset 262, the decontamination system 200 may be invoked to perform a decontamination of the training dataset 262. The decontamination system 200 accesses the benchmark dataset(s) 252 available from benchmark data source computing system 250 and the training dataset 262 from the training data source computing system 260 via the one or more data networks 202. The decontamination system 200 executes the content-sharing data identification engine 210 on the benchmark dataset 252 and the training dataset 262 to identify content-sharing data, i.e., instances of strings in the benchmark dataset 252 that are also present in the training dataset 262. A string matching engine 214 of the content-sharing data identification engine 210 perform string matching between the datasets 252-262 and identifies strings that are common between the two.

If strings in the benchmark dataset 252 are present in the training dataset 262, these common strings, referred to as content-sharing data, are regarded as potential contamination and the corresponding benchmark dataset ID of the benchmark data 252 whose strings are matched, is attached to the training data sample where the content-sharing data is present. Thus, training data sample metadata comprises annotations specifying which benchmark datasets in the benchmark data 252 have matching strings. These annotations also identify training data samples that are candidates for removal as part of the decontamination operation as described hereafter.

Before the string matching engine 214 performs the actual string matching between the benchmark datasets 252 and the training data 262, the normalization engine 212 may execute normalization operations on the benchmark datasets 252 and the training dataset 262. These normalizations may include white space removal, special characters (e.g., newline characters) removal, conversion of upper case to lower case, and the like. In addition, the string matching engine 214 may implement other techniques to enhance the string matching performed, including exclusion of short strings having a length below a given threshold, so as to eliminate frequently used code snippets that may lead to false positives. Moreover, the string matching engine 214 may perform comment removal to remove comment lines in code of the benchmark dataset 252 samples and the training data 262 samples, before performing string matching.

To reduce computational costs of the string matching, the metadata evaluation engine 216 of the content-sharing data identification engine 210 may perform an evaluation of the metadata of the benchmark datasets 252 and the training data 262 to determine when string matching can be skipped. That is, metadata attributes may be evaluated between the datasets 252 and 262 to determine instances where string matching will not generate good results. For example, the metadata of the datasets 252 and 262 may specify the particular programming languages of data samples in the datasets 252, 262 and if there is a mismatch, e.g., when the programming language of the benchmark data and the training data are different, string matching by the string matching engine 214 may be skipped for that portion of the training dataset 262. In addition, the data cleansing engine 218 may operate to cleanse the training dataset 262 by performing deduplication of the training data samples in the training dataset 262. Moreover, the data cleansing engine 218 may perform deduplication of strings with regard to the benchmark datasets 252, such that when there are overlaps of strings in a same benchmark dataset 252, they are merged into one string for purposes of string matching with the training dataset 262.

The content-sharing data identification engine 210 thus, identifies content-sharing data present in the pairing of benchmark datasets 252 and a training dataset 262. The content-sharing data may be maintained in a data structure 219 for use in identifying contaminated repositories. That is, the content-sharing data is used to search repository data 272 of repositories 270 for instances of the content-sharing data (data having matching strings between the benchmark datasets 252 and the training dataset 262) to determine which repositories 270 are potentially contaminated with benchmark data. As previously mentioned above, the repositories store documents used by code generation LLMs, such as code generation LLM 290, to perform code generation operations. The documents may have various types of content including actual computer code in various programming languages, natural language text code explanations, computer code issues and commits, and the like.

The content-sharing data matching engine 222 of the contaminated repository identification engine 220 performs a type of string matching between the content-sharing data identified by the content-sharing data identification engine 210, e.g., stored in data structure 219, and the repository data 272 of the repository. Instances of content-sharing data in the content of the repository data 272 may be maintained to determine contamination metrics for the repositories 270. These contamination metrics may be a numerical representation of a number of instances of content-sharing data in the repository data 272, a number of unique instances of content-sharing data in the repository data 272, a percentage of the repository data 272 having content-sharing data, a function of a ratio of documents having content-sharing data to a total number of documents in a repository, or any other suitable metric for measuring a degree of contamination of the repository data 272 with content-sharing data. In this way, the repositories 270 are evaluated as to how much content is common between the repository data 272, the benchmark dataset 252, and the training dataset 262.

In some illustrative embodiments, the contamination metrics may further include an evaluation of a function of the length of the content-sharing data string instances that are present in the repository data 272. That is, longer length strings represent a greater degree of contamination than shorter length strings, where shorter length strings are also more likely to be false positives. Thus, depending on the length of the matching content-sharing data, different values of contamination metrics may be associated with the repository data 272.

The repository scoring and ranking engine 224 operates to score and rank the repositories 270 based on the contamination metrics. Examples of such repository scoring and ranking have been provided above, but any suitable scoring and ranking for identifying potentially contaminated repositories may be utilized. Based on the scoring and/or ranking of the frequency of occurrence of the content-sharing data, a listing of repositories, i.e., repositories listing data structure 226, and the scores/ranks may be generated that indicate which repositories are more/less contaminated with benchmark data. Thresholds may be established for determining when the degree of potential contamination is such that the repository 270 should be considered contaminated for purposes of decontamination of training datasets 262.

In some illustrative embodiments, the metadata evaluation engine 323 of the contaminated training data identification engine 230 utilizes the identifications of contaminated repositories 270 to evaluate the metadata of training data samples in the training dataset 262 to identify training data samples originating from those contaminated repositories 270. In such embodiments, any instances of training data samples that originate from the contaminated repositories 270 may be considered contaminated and may be flagged for decontamination. Thus, for a subsequent evaluation of a training dataset, this comparison of the metadata of the training data samples and the listing of contaminated repositories 270 may be performed before performing any other string matching between the benchmark datasets 252 and the training dataset 262 to identify potential contamination. That is, in some illustrative embodiments, the metadata evaluation engine 232 identifies any training data samples originating from a contaminated repository 270 (as identified by the mechanisms of the illustrative embodiments) and flags them for removal as part of decontamination operations. Moreover, string matching, such as performed by the string matching engine 214, between the benchmark dataset 252 and the remaining portions of the training dataset 262 may then be performed, subject to the attribute evaluations and other optimizations mentioned above to speed up the string matching, e.g., normalization, skipping string matching for different programming languages, and the like. This reduces the overhead of the string matching operation by targeting the string matching on only a subset of the training dataset and thereby reduces computational costs.

In these embodiments, the metadata evaluation by the metadata evaluation engine 232 and the string matching of the remaining portions of the training data, results in an annotated training dataset having annotations indicating portions of the training dataset originating from a contaminated repository and portions of the training dataset that otherwise comprise content-sharing data. The annotated training dataset may then be input to the decontamination engine 240 which removes the flagged portions of the training dataset from the training dataset to thereby generate the decontaminated training dataset 242. The decontaminated training dataset 242 is a reduced size training dataset 242 having the potentially contaminated training data samples removed.

The decontaminated training dataset 242 may then be stored in the training dataset source computing system 260 for future use with training code generation LLMs, such as code generation LLM 290. The decontaminated training dataset 242 may be provided to the code generation LLM training engine 280 for use in training the code generation LLM 290. The decontaminated training dataset 242 does not include training data samples originating from contaminated repositories or that have strings matching strings in the benchmark datasets 252. Thus, once the code generation LLM 290 is trained, its training is not biased towards the benchmark datasets 252. Hence, the benchmark datasets 252 may be used to accurately test the trained code generation LLM 290 and accurately evaluate its performance.

The above illustrative embodiments may be used to reduce instances of false negatives in the content matching by assuming that all training data originating from a contaminated repository are in fact contamination in the training dataset. This may be the case even for forked repositories that originate from a contaminated repository, as the forked repository may be assumed to be also contaminated. In such embodiments, the training datasets may be decontaminated by not only removing instances of content-sharing data detected based on string matching between the benchmark data and the training data, but also based on metadata specifying the repository source of training data. That is, for training data samples that originate from a contaminated repository, those training data samples may be removed from the training dataset without having to perform string matching between the benchmark data and the training dataset. The remaining training dataset samples may then be subjected to string matching between the benchmark dataset and the training dataset to identify instances of content-sharing data which may then be removed from the training dataset.

Thus, once the contaminated repositories listing data structure 226 is generated, for subsequent training dataset decontamination operations, an initial step may be to compare the metadata of the training data samples to the listing to identify which training data samples originate from a contaminated repository and remove those from the training dataset. The remaining training dataset may then be subjected to the optimized string matching operations to identify remaining portions that are potentially contaminated and have those additional portions also removed as part of decontamination.

In other illustrative embodiments, the repositories listing data structure 226 that are potentially contaminated, i.e., contain content-sharing data to a sufficient degree that they are considered contaminated for purposes of decontaminating training datasets, may be used to identify which portions of the training dataset 262 flagged as potentially contaminated by the string matching operation to identify content-sharing data, are actual contamination of the training data by benchmark data, and which may be false positives. That is, in these illustrative embodiments, the mechanisms of the content-sharing data identification engine 210 identifies matching string instances between the benchmark dataset 252 and the training dataset 262. These are potential contamination and may include false positives. Thus, to distinguish between false positives and true positives, those training data samples flagged as potential contamination may be further evaluated against the repositories listing data structure 226 and if they originate from a contaminated repository, they may be considered true positives and removed through decontamination. Any instances which do not originate from a contaminated repository may be considered a false positive and not subject of the decontamination and may remain in the training dataset. Thus, a more fine-grained evaluation of the potentially contaminated training datasets may be performed to distinguish between false positives and true positives.

As can be seen from the above, the illustrative embodiments provide computer tools and computer operations/functionality to decontaminate a training dataset with regard to benchmark data. This may be done using a combination of metadata based identification of training data samples that originate from identified contaminated repositories, as well as string matching. In some illustrative embodiments, false positives and true positives may be distinguished based on such metadata and the identification of contaminated repositories. The resulting decontaminated training dataset may then be provided to training logic for training a code generation LLM. As a result, the trained code generation LLM will not be trained on benchmark data and hence, the benchmark datasets may be accurately used to evaluate the performance of the trained code generation LLM.

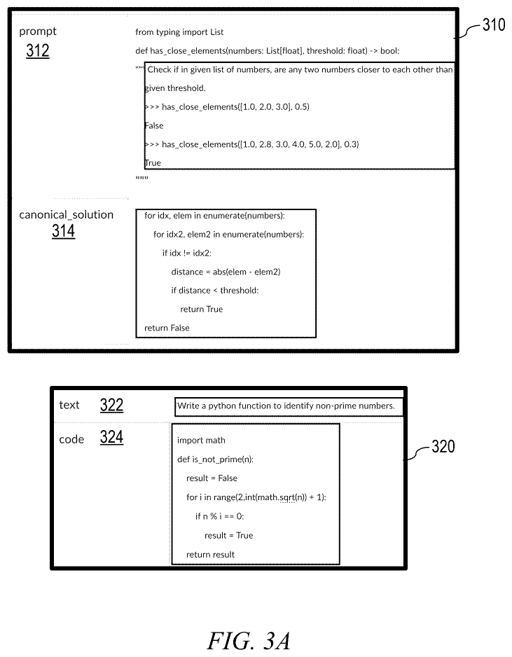

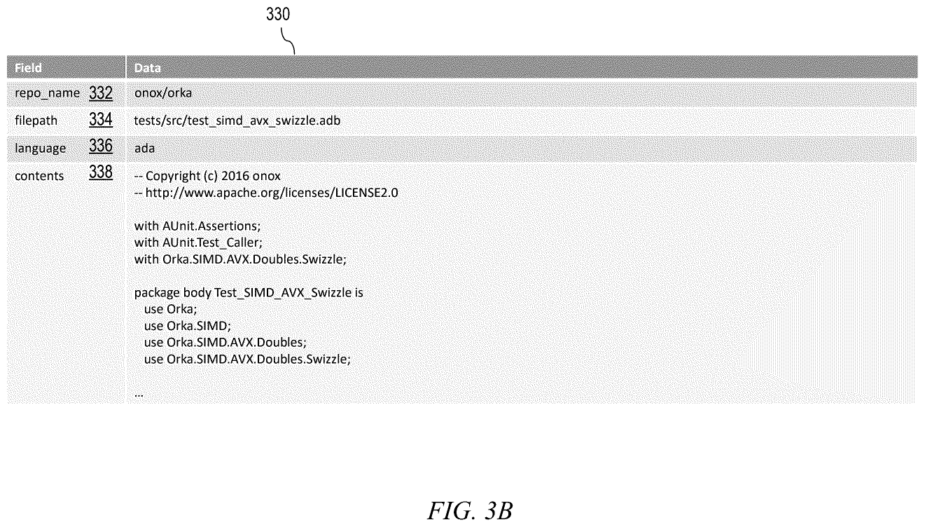

As noted above, the illustrative embodiments operate on benchmark data samples and repository data, which may comprise metadata describing various attributes of the repository data. FIG. 3A is an example diagram of examples of benchmark data samples in accordance with one illustrative embodiment. FIG. 3A shows two examples of benchmark data from benchmark datasets. In a first example 310, the benchmark data samples comprise a prompt 312 and a canonical solution 314. The prompt 312 specifies a problem that the code generation LLM is to solve by the generation of code to perform the requested operation in the prompt 312. The canonical solution comprises the code that the code generating LLM should generate to solve the problem specified in the prompt 312. The strings in the prompt 312 and the canonical solution 314 may be used for string matching against the training dataset to identify content-sharing data which may have a similar format.

In the second example 320, the benchmark data sample comprises an input text 322 specifying in natural language the task that the user wishes the code generation LLM to perform, e.g., “write a python function to identify non-prime numbers”. The code 324 is the result that should be generated by the code generation LLM to satisfy the request in the text 322. Again, the strings in this example may be used to perform string matching against the training dataset to identify content-sharing data. The example prompt 312 in FIG. 3A includes a part of Python code to import modules and define function prototypes, and narrative instruction expressed as a comment of Python code. Instead of using these whole strings for string matching, the instruction portion embedded in the comment (within the outlined box) is used for string match with training data. In the example 320 the text and code are used as they are for these purposes.

FIG. 3B is an example diagram of a record of a repository with corresponding metadata in accordance with one illustrative embodiment. As shown in FIG. 3B the repository record 330 comprises a plurality of metadata fields 332, 334, 336 and contents 338. The metadata field 332 specifies a repository name for the repository in which the record is present. The metadata field 334 specifies the file path for the contents 338 and the metadata field 336 specifies the programming language for the contents 338. This same metadata will travel with any training data sample generated from this record and will be associated with the training data sample in the training dataset. Thus, the metadata field 336 may be used to determine when to skip string matching based on differences in programming language. Moreover, the metadata field 332 may be used to identify portions of training datasets originating from this repository, such as in the case that the repository is determined to be contaminated.

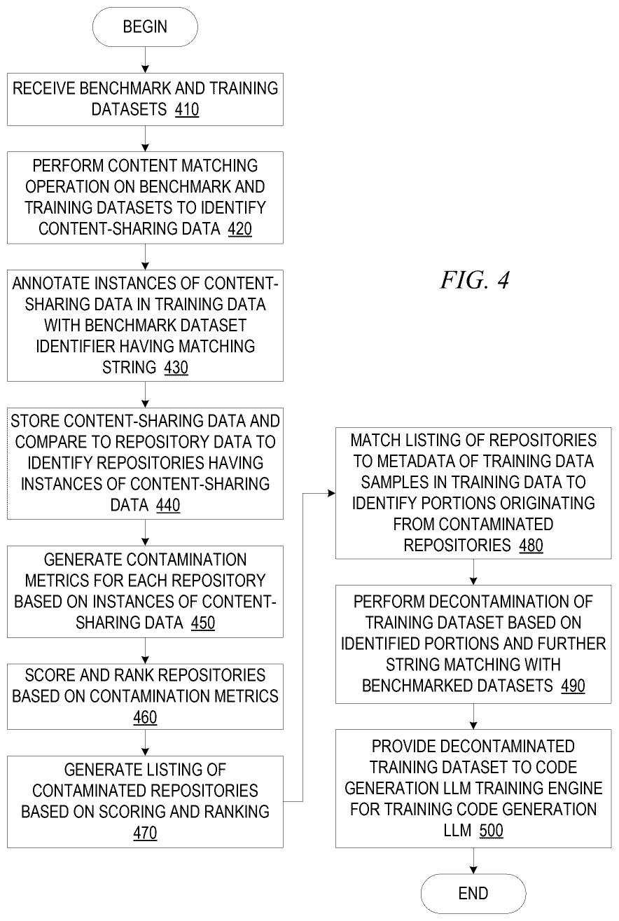

FIG. 4 is a flowchart outlining an example operation of a decontamination system in accordance with one illustrative embodiment. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

As shown in FIG. 4, the operation starts by receiving one or more benchmark datasets and a training dataset that is to be decontaminated (step 410). A content matching operation is performed between the benchmark datasets and the training datasets to identify content-sharing data (step 420). The instances of content-sharing data in the training dataset are annotated with the identifier of the benchmark dataset that has one or more matching strings (step 430). The content-sharing data is stored and compared to repository data to identify repositories having instances of the content-sharing data (step 440). Contamination metrics for each repository are generated based on the instances of content-sharing data in the repositories (step 450). The repositories are scored based on their contamination metrics and ranked (step 460). A listing of contaminated repositories is generated based on the scoring and ranking (step 470). The listing of contaminated repositories is used to match against metadata of the training data samples in the training dataset to identify portions originating from contaminated repositories (step 480). Decontamination of the training dataset is then performed based on the identified portions originating from contaminated repositories and further based on string matching between the benchmarked datasets (step 490). The decontaminated training dataset is then input to a code generation LLM training engine for training a code generation LLM (step 500). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
performing content matching between benchmark data and training data to thereby identify content-sharing data, wherein the content-sharing data comprises strings that are common between the benchmark data and the training data;
identifying one or more repositories that contain instances of the content-sharing data;
generating one or more contamination metrics for each repository in the one or more repositories, based on a frequency of the instances of the content-sharing data in the one or more repositories;
identifying one or more contaminated repositories in the one or more repositories based on the one or more contamination metrics for each repository;
decontaminating the training data based on the identification of the one or more contaminated repositories and metadata of training data samples in the training data; and
training a machine learning computer model based on the decontaminated training data.

2. The method of claim 1, wherein decontaminating the training data comprises, for each training data sample in the training data:
comparing one or more first attributes of the training data sample in the metadata of the training data sample, to one or more second attributes of the one or more contaminated repositories; and
in response to identifying a match of at least one first attribute of the training data sample with an at least one second attribute of a contaminated repository of the one or more contaminated repositories, removing the training data sample from the training data.

3. The method of claim 2, wherein the one or more first attributes comprises an identifier of a source repository from which a corresponding training data sample was obtained, and wherein the one or more second attributes comprises a repository identifier of a corresponding contaminated repository.

4. The method of claim 1, wherein decontaminating the training data comprises performing a preprocessing of the training data to identify portions of the training data which are not to be a target for decontamination, wherein the preprocessing comprises identifying portions of the training data that are in a different computer programming language from a programming language of the benchmark data.

5. The method of claim 1, wherein the one or more contamination metrics comprises at least one of a number of instances of content-sharing data in the one or more repositories or a number of unique instances of content-sharing data in the one or more repositories.

6. The method of claim 1, wherein the one or more contamination metrics comprises a degree of contamination of a corresponding repository, wherein the degree of contamination is a function of a ratio of a number of documents in the corresponding repository having instances of the content-sharing data to a total number of documents of the corresponding repository.

7. The method of claim 1, wherein performing content matching between benchmark data and training data to thereby identify the content-sharing data further comprises annotating training data samples in the training data that have content-sharing data with a benchmark annotation specifying an identifier of the benchmark data, wherein training data samples annotated with a benchmark annotation are candidates for removal from the training data.

8. The method of claim 1, wherein the one or more contamination metrics comprise a function of a length of content-sharing data string instances present in a corresponding repository.

9. The method of claim 1, wherein the machine learning computer model is a code generation large language model (LLM).

10. The method of claim 9, wherein the one or more repositories are code generation repositories comprising documents used by the code generation LLM to generate computer code to perform a function specified in a prompt input to the code generation LLM.

11. A computer program product comprising:
one or more computer-readable storage media; and
program instructions stored on the one or more computer-readable storage media to perform operations comprising:
performing content matching between benchmark data and training data to thereby identify content-sharing data, wherein the content-sharing data comprises strings that are common between the benchmark data and the training data;
identifying one or more repositories that contain instances of the content-sharing data;
generating one or more contamination metrics for each repository in the one or more repositories, based on a frequency of the instances of the content-sharing data in the one or more repositories;
identifying one or more contaminated repositories in the one or more repositories based on the one or more contamination metrics for each repository;
decontaminating the training data based on the identification of the one or more contaminated repositories and metadata of training data samples in the training data; and
training a machine learning computer model based on the decontaminated training data.

12. The computer program product of claim 11, wherein decontaminating the training data comprises, for each training data sample in the training data:
comparing one or more first attributes of the training data sample in the metadata of the training data sample, to one or more second attributes of the one or more contaminated repositories; and
in response to identifying a match of at least one first attribute of the training data sample with an at least one second attribute of a contaminated repository of the one or more contaminated repositories, removing the training data sample from the training data.

13. The computer program product of claim 12, wherein the one or more first attributes comprises an identifier of a source repository from which a corresponding training data sample was obtained, and wherein the one or more second attributes comprises a repository identifier of a corresponding contaminated repository.

14. The computer program product of claim 11, wherein decontaminating the training data comprises performing a preprocessing of the training data to identify portions of the training data which are not to be a target for decontamination, wherein the preprocessing comprises identifying portions of the training data that are in a different computer programming language from a programming language of the benchmark data.

15. The computer program product of claim 11, wherein the one or more contamination metrics comprises at least one of a number of instances of content-sharing data in the one or more repositories or a number of unique instances of content-sharing data in the one or more repositories.

16. The computer program product of claim 11, wherein the one or more contamination metrics comprises a degree of contamination of a corresponding repository, wherein the degree of contamination is a function of a ratio of a number of documents in the corresponding repository having instances of the content-sharing data to a total number of documents of the corresponding repository.

17. The computer program product of claim 11, wherein performing content matching between benchmark data and training data to thereby identify the content-sharing data further comprises annotating training data samples in the training data that have content-sharing data with a benchmark annotation specifying an identifier of the benchmark data, wherein training data samples annotated with a benchmark annotation are candidates for removal from the training data.

18. The computer program product of claim 11, wherein the one or more contamination metrics comprise a function of a length of content-sharing data string instances present in a corresponding repository.

19. The computer program product of claim 11, wherein the machine learning computer model is a code generation large language model (LLM), and wherein the one or more repositories are code generation repositories comprising documents used by the code generation LLM to generate computer code to perform a function specified in a prompt input to the code generation LLM.

20. A computer system comprising:
a processor set;
one or more computer-readable storage media; and
program instructions stored on the one or more computer-readable storage media to cause the processor set to perform operations comprising:
performing content matching between benchmark data and training data to thereby identify content-sharing data, wherein the content-sharing data comprises strings that are common between the benchmark data and the training data;
identifying one or more repositories that contain instances of the content-sharing data;
generating one or more contamination metrics for each repository in the one or more repositories, based on a frequency of the instances of the content-sharing data in the one or more repositories;
identifying one or more contaminated repositories in the one or more repositories based on the one or more contamination metrics for each repository;
decontaminating the training data based on the identification of the one or more contaminated repositories and metadata of training data samples in the training data; and
training a machine learning computer model based on the decontaminated training data.
